(19) United States
(12) Patent Application Publication
(10) Pub. No.: US 2026/0267629 A1
(43) Pub. Date: Sep. 10, 2026

(54) PROVIDING SEPARATE IMAGES FOR STORAGE IN A COMMON MEMORY

(71) Applicant: Silicon Laboratories Inc., Austin, TX (US)

(72) Inventors: Shashwat Gupta, Georgetown, TX (US); Bryan Murawski, Belmont, MA (US)

(21) Appl. No.: 19/070,674

(22) Filed: Mar. 5, 2025

(51) Int. Cl. G06F 8/61; G06F 8/41; G06F 8/54; G06F 9/448

(52) U.S. Cl. CPC G06F 8/63; G06F 8/44; G06F 8/54; G06F 9/4486

(57) ABSTRACT

In one embodiment, a method comprises: executing, on a radio coprocessor of a wireless device, protocol code for a wireless protocol, the protocol code comprising a first call to a first application programming interface of radio code, the radio code separate from the protocol code; in response to the first call, accessing a jump table using a jump table pointer included in the protocol code; using the jump table to identify a location of the first application programming interface within the radio code; and accessing the first application programming interface within the radio code at the location.

### BACKGROUND

It is common during software development for code of different functionality that may be provided in different binary images to be fused together into a single binary image, such that each of the underlying binary images has knowledge of functionality present in the other image. For example, when commonly developing a single image in this manner, information regarding location of code symbols such as functions of a first underlying image is made visible to the other underlying image so that it can access such symbols, and vice versa. Further, a single linker file is associated with the resulting single image, which is flashed to memory. Requiring common development of these separate images increases complexity and prevents flexibility, and raises development costs.

### SUMMARY OF INVENTION

In one aspect, a method includes: generating a first executable file for radio code to execute on at least one coprocessor of a wireless device, the first executable file having a pointer to a jump table, the jump table having a plurality of entries each to identify an entry point to a function in the radio code, the radio code to be used for a plurality of wireless protocols; generating a second executable file for protocol code to execute on the at least one coprocessor, the second executable file having the pointer to the jump table, the protocol code to be used for one of the plurality of wireless protocols; building, using the first executable file and the second executable file, a host application having the radio code separated from the protocol code, the host application to execute on a host processor of the wireless device; and storing the host application in a non-volatile memory.

In one implementation, the method further comprises: generating a first source file for the radio code and generating a second source file for the protocol code; and associating a first linker file with the radio code and associating a second linker file with the protocol code, the first linker file comprising the pointer and the second linker file comprising the pointer. The method may also include: generating the first executable file using the first source file and the first linker file; and generating the second executable file using the second source file and the second linker file.

In one implementation, building the host application comprises including instructions in the host application to cause the host processor to independently load the radio code to a first location in a memory of the wireless device and load the protocol code to a second location in the memory, where the memory may be a volatile memory associated with the at least one coprocessor. The method may also comprise including the instructions in the host application to cause the host processor to independently load the radio code comprising the jump table, the pointer to identify a location of the jump table.

In another aspect, an apparatus includes: a host processor to execute applications; and a wireless transceiver coupled to the host processor, the wireless transceiver comprising radio frequency (RF) circuitry, at least one radio coprocessor, a non-volatile memory and a volatile memory, wherein the host processor is to independently load a radio image into a first location of the volatile memory and load a protocol image into a second location of the volatile memory, wherein the radio image is separated from the protocol image in the volatile memory.

In one implementation, the host processor further is to independently load the radio image comprising a jump table, the jump table having a plurality of entries each to identify an entry point to a function in the radio image. The radio image may include a pointer to the jump table and the protocol image also may include the pointer to the jump table. The at least one radio coprocessor is, during execution of the protocol image, to access a first application programming interface of the radio image using the pointer. The at least one radio coprocessor is to obtain an offset to the first application programming interface in a header of the protocol image, the header to associate the offset with the first application programming interface.

In an implementation, the host processor is to independently load a second protocol image into a third location of the volatile memory, wherein the protocol image is associated with a first wireless protocol and the second protocol image is associated with a second wireless protocol. The host processor may be configured to dynamically swap a second protocol image for the protocol image in response to a switch of the wireless transceiver from communication via a first wireless protocol to communication via a second wireless protocol.

In a still further aspect, a method comprises: executing, on a radio coprocessor of a wireless device, protocol code for a wireless protocol, the protocol code comprising a first call to a first application programming interface of radio code, the radio code separate from the protocol code; in response to the first call, accessing a jump table using a jump table pointer included in the protocol code; using the jump table to identify a location of the first application programming interface within the radio code; and accessing the first application programming interface within the radio code at the location.

In one implementation, the method further comprises: obtaining an offset to an entry of the jump table associated with the first application programming interface; and accessing the entry of the jump table using the jump table pointer and the offset, the entry comprising the location of the first application programming interface within the radio code. The method may also include executing the first application programming interface to perform an operation, and executing, on the radio coprocessor, the protocol code using a result of the operation.

In an implementation, the method further comprises dynamically swapping, in a memory of the wireless device, the protocol code with second protocol code for a second wireless protocol, while maintaining the radio code in a memory. The method also may include: loading, via a host processor of the wireless device, the radio code into a first location of a volatile memory of the wireless device; and loading, via the host processor, the protocol code into a second location of the volatile memory, wherein the radio code is separated from the protocol code in the volatile memory. The method may also include independently loading the radio code from a first location in a non-volatile memory of the wireless device, and thereafter independently loading the protocol code from a second location in the non-volatile memory.

### BRIEF DESCRIPTION OF THE DRAWINGS

FIG. 1 is a flow diagram of a method in accordance with an embodiment.

FIG. 2 is a graphical illustration of an application development process in accordance with an embodiment.

FIG. 3 is a flow diagram of a method in accordance with another embodiment.

FIG. 4 is a block diagram of a memory in accordance with an embodiment.

FIG. 5 is a block diagram of a representative integrated circuit in accordance with an embodiment.

FIG. 6 is a high-level diagram of a network in accordance with an embodiment.

### DETAILED DESCRIPTION

In various embodiments, code for performing radio operations in a wireless device can be designed using a process in which separate images are formed independently and at potentially different stages of development. Nevertheless, these separate images can be generated in a manner to provide visibility to the symbols included in these different images. In this way, independent and more flexible software development of the separate code images can be realized, while at the same time providing binaries that can seamlessly work together and be flashed to a given non-volatile memory in a single flash operation. Note that the terms “binary,” “image” and “code image” are used interchangeably to refer to software code maintained in a machine-readable format. In turn, the separate images can be independently loaded into a common memory for execution, e.g., random access memory (RAM).

While embodiments described herein are in the context of radio code that may execute on one or more radio coprocessors of a wireless device, embodiments are not limited in this regard and the techniques described herein enable development, manufacture and use of separate code images of various functionality that can interact in a seamless manner.

For purposes of discussion, multiple independent code images can be developed and stored in a common memory for execution. These separate images include first code having instructions for use in operating underlying radio hardware. This code is referred to herein as radio code, which is an implementation of radio abstraction interface layer (RAIL) code, and which may execute as a radio state machine. This RAIL code may be implemented as a radio driver that provides access to generic radio operations, such as transmit and receive of data packets. This first code may be used in controlling radio hardware regardless of an underlying wireless protocol. In turn, the separate images also include second code, referred to herein as protocol user code (or equally ‘protocol code’), having instructions that correspond to a user application for a protocol stack of a given wireless protocol. Note that the software code described herein includes instructions for execution in a sequenced manner by a processor having next instruction pointer capabilities such as a given coprocessor, e.g., to execute instructions of a complex instruction set computing (CISC) or reduced instruction set computing (RISC) instruction set architecture. Understand of course that embodiments may be used for providing separate but interacting code images of other variations.

As examples, protocol code in accordance with an embodiment may be associated with a particular wireless protocol, such as a Bluetooth protocol. Understand that multiple such protocol code instantiations may be provided, with each instantiation associated with a particular wireless protocol. Also understand that all of these protocol code instantiations may operate in conjunction with the single radio code. Depending on implementation, both the radio code and the protocol user code may execute on a single radio coprocessor, or they may execute on separate coprocessors. In yet other cases, such code may execute on a host processor.

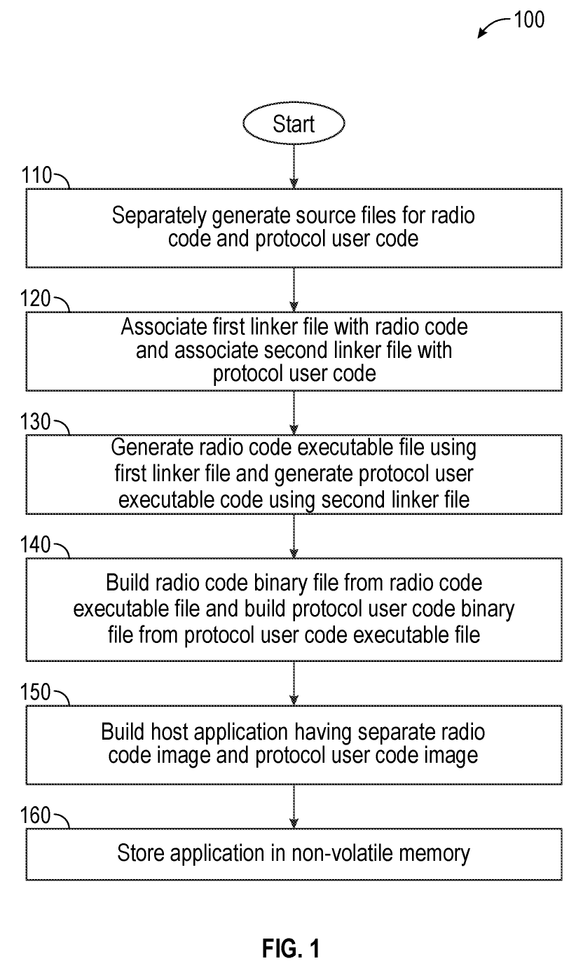

Referring now to FIG. 1, shown is a flow diagram of a method in accordance with an embodiment. More specifically, method 100 of FIG. 1 is a method for independently developing an application having separate code images as described herein. In embodiments, method 100 may be performed by one or more computer systems, e.g., using various software development tools such as a Makefile development tool.

As shown, method 100 begins by separately generating source files for radio code and protocol user code (block 110). Such source files may be generated in a given language such as a C language. Next at block 120, a first linker file may be associated with the radio code, and a second linker file may be associated with the protocol user code. Understand that these linker files may be generated at build time; that is, dynamically or on-the-fly during development. By providing separate linker files, complexity is avoided. For example, the protocol user code can avoid the need for identifying internal addresses to standard library symbols that may be present within the radio code. Still further, there is no need for the protocol user code to provide a list of files (e.g., .c files) and symbols. Instead, these separate linker files are provided to control where the executables of the separate protocol user code and radio code are to reside in memory. Note however that both linker files may include a common pointer to an address of a so-called jump table, details of which are described further below. By provision of this common pointer, both code images can access information in this jump table.

Still referring to FIG. 1, next at block 130, executable files may be generated for the radio and protocol user code. More specifically, the first user file may be used to generate the radio code executable file, and the second linker file may be used to generate the protocol user code executable file. These executable files may be generated as .elf files. Thereafter at block 140, binary files may be built from these executable files. More specifically, via a binary conversion process, these executable files may be converted to binary files (namely separate binary (.bin) files) for the radio code and the protocol user code.

At this point, the images may be considered to have completed the build process. Next, method 100 continues by building a host side application. Still referring to FIG. 1, at block 150, this host application may be built having separate radio and protocol user images. In an embodiment, the binary files may be parsed to parse out the symbols of these files to place them into a map file and generate the corresponding application file, e.g., as an .c application. Note that this host application is for execution on a host processor of a device, e.g., a host processor of a multi-protocol wireless system on chip (SoC) or another device having a wireless transceiver. During execution, the host processor may execute the host application to cause the included radio image and protocol user image to be independently loaded into a common memory for execution, e.g., by a coprocessor of the SoC.

Finally at block 160, the application may be stored in a non-volatile memory. For example, the application can be stored in a mass storage of the one or more computing systems. At some point later, understand that the host application can be loaded within a non-volatile memory of wireless devices under manufacture. For example, in an implementation in which this host application is to execute on a transceiver integrated circuit (IC) such as a multi-protocol transceiver SoC IC, the host application can be flashed into a non-volatile memory, e.g., flash memory of the IC.

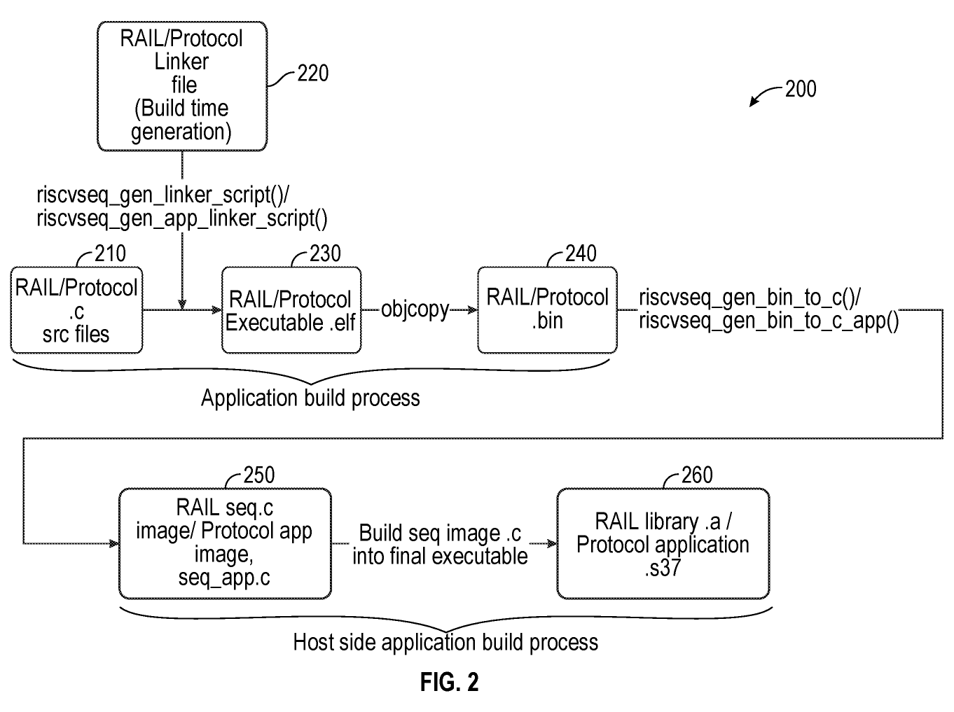

Referring now to FIG. 2, shown is a graphical illustration of an application development process in accordance with an embodiment. In FIG. 2, diagram 200 illustrates the various files present at different stages of the build process. As seen, the process begins with underlying source files (shown in FIG. 2 at block 210 as RAIL/protocol .c source (.src) files). Thus, this nomenclature contemplates the separate build-time generation of separate radio (RAIL) and user (protocol) components. Next using corresponding linker files that are generated at build time (shown at block 220), executable files may be separately generated (shown at block 230 as .elf files). Next a binary conversion process is performed, resulting in corresponding binary (.bin) files, as shown at block 240. Thus, at this point, the application build process is completed.

Next a host side application build process occurs, as shown at block 250. The binaries may be converted to .c images, which are built into a final executable, at block 260. As described, this overall host application includes the separate images for the radio code and protocol user code. Further, while discussed with a single protocol user code for ease of discussion, in a given implementation there can be as many protocol user code images as a number of wireless protocols supported by a given device. Although shown at this high level in the embodiment of FIG. 2, many variations and alternatives are possible.

As described above, the separate radio and protocol images are implemented in a wireless device within the same non-volatile memory, and may be considered to be firmware for the wireless device. Also as described above, these separate images are provided with a common pointer to enable access to a jump table. This jump table provides information regarding a location of symbols, e.g., functions such as application programming interfaces (APIs), within the radio code. Using the jump table, protocol user code may seek to access such functions within the radio code via calls to such APIs.

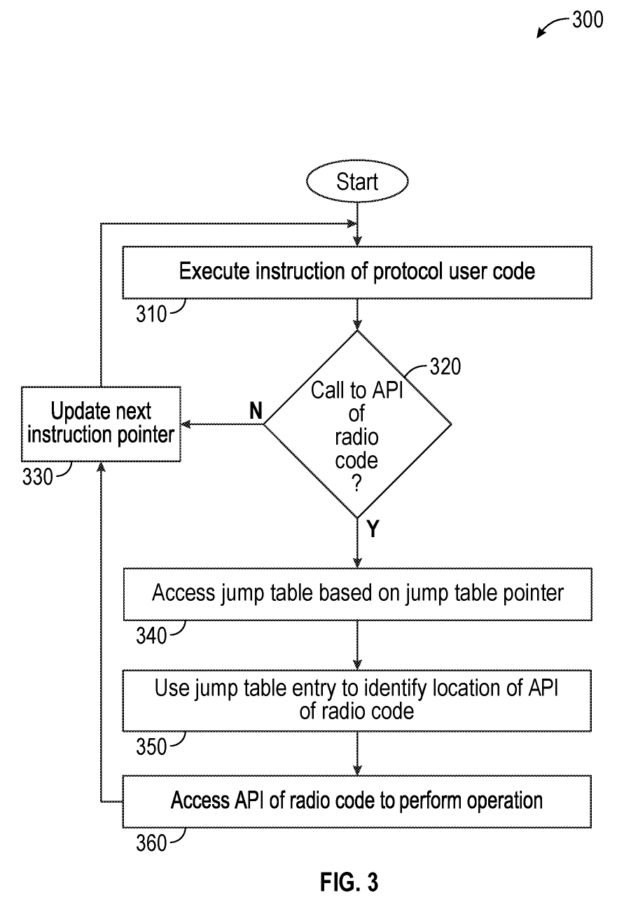

Referring now to FIG. 3, shown is a flow diagram of a method in accordance with another embodiment. More specifically, method 300 illustrates execution of a portion of protocol user code in accordance with an embodiment. Such execution may be performed by a radio coprocessor, such as a RISC-V processor; of course, the code can be executed on other processing units. Method 300 begins by execution of an instruction of the protocol user code (block 310). It is determined at diamond 320 whether this instruction is a call to an API of the radio code. If not, the instruction may execute and a next instruction pointer can be updated to point to a next instruction of the protocol user code (block 330).

Instead, when it is determined that a given instruction is a call to an API of the radio code, control passes to block 340. At block 340, a jump table may be accessed based on a jump table pointer. Note that this jump table pointer is included within the protocol user code (and note further that this same pointer is included in the radio code). More specifically, this pointer is a pointer to a base address of the jump table, which is stored in a common RAM with the protocol user code and the radio code.

In some implementations this jump table may be included within the radio code image, or in other cases can be separate from the two images. At block 340, the jump table may be accessed based on the jump table pointer. Then at block 350, a jump table entry may be used to identify the location of the API within the radio code. Here, an offset within the jump table may be added to the base address to access the particular jump table entry for the given API. To this end, the protocol user code may include a header or other data structure that maintains a listing of the APIs of the radio code that it is allowed to access and corresponding offsets in the jump table for these APIs. With the location thus obtained from the accessed entry in the jump table, control passes to block 360, where the API of the radio code may be accessed. Accordingly, whatever operations of the API are performed. After any resulting data is passed back to the protocol user code, operation passes back to block 330 for the update to the next instruction pointer for continued execution of the protocol user code. Although shown at this high level in the embodiment of FIG. 3, many variations and alternatives are possible.

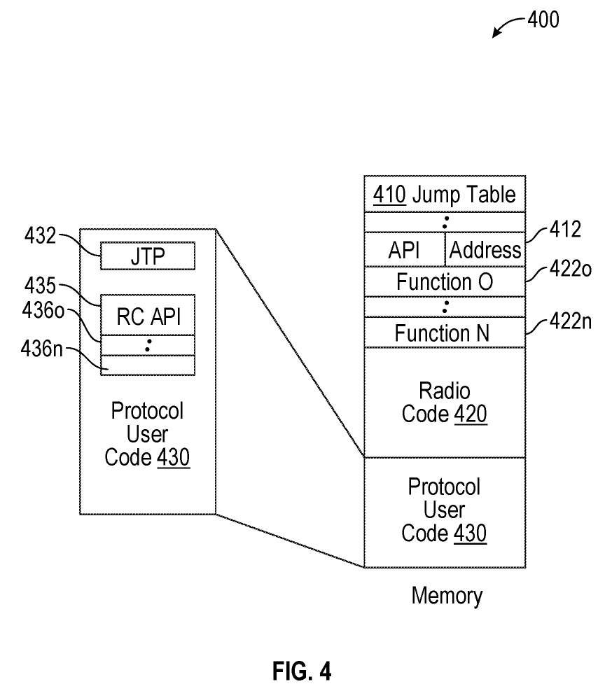

Referring now to FIG. 4, shown is a block diagram of a memory in accordance with an embodiment. As shown in FIG. 4, memory 400 may be a given memory such as a RAM that is associated with one or more coprocessors on which radio code and protocol user code execute. More particularly, memory 400 may be a dedicated memory for at least one coprocessor, e.g., a RISC-V processor, and which may be implemented in a common power domain with the coprocessor.

In the high level view shown in FIG. 4, memory 400 includes a jump table 410 included as part of radio code 420 and protocol user code 430. Note that each of these code blocks may be stored at separate locations within memory 400 and may be loaded independently from a common non-volatile memory to memory 400 by a host processor.

As shown, jump table 410 may be located at a start of memory 400, and includes entries to provide information to locations of APIs within radio code 420. A single representative entry 412 of jump table 410 is shown, which includes an identification of a particular API and an address to a location of the API within radio code 420. As described above, jump table 410 may be accessed using a jump table pointer (marked as “JTP” 432 within protocol use code 430), and a corresponding entry 412 within jump table 410 may be accessed based on offset information, e.g., such as included in entry of a header of protocol user code 430. In turn, radio code 420 includes various instructions for execution. In the high-level view shown in FIG. 4, a plurality of functions 422_{0-N} may be included, where each of these functions may perform requested operation(s) for a given one of the APIs.

Still referring to FIG. 4, protocol user code 430 is illustrated in the inset of FIG. 4 as including a jump table pointer (JTP) 432, which is a pointer to the base address of jump table 410. In addition, protocol user code 430 includes a data structure 435, such as a header that identifies corresponding APIs within radio code 420. As shown, data structure 435 may include a plurality of entries 436_{0-N}, each of which identifies a given API and provides an offset to a given entry within jump table 410 for that API. Although shown at this high level in the embodiment of FIG. 4, variations and alternatives are possible.

For example, while a single instance of protocol user code is illustrated, understand that with an appropriately-sized memory 400, multiple such images may be stored, each for a given wireless protocol. For example, there may be separate protocol user images for each of Bluetooth Classic, Bluetooth Low Energy (BLE), and/or Wi-Fi protocols (and/or of other IEEE specifications such as IEEE 802.15.4 protocols). In other cases, such as where the size of memory is constrained, only a single protocol user code may be loaded at a given time. Upon a radio switch to another wireless protocol, a different protocol user code can be loaded into the memory, e.g., overriding at least a portion of previously stored protocol user code. Note however that the single radio code image remains stored, as this code is independent of underlying wireless protocol.

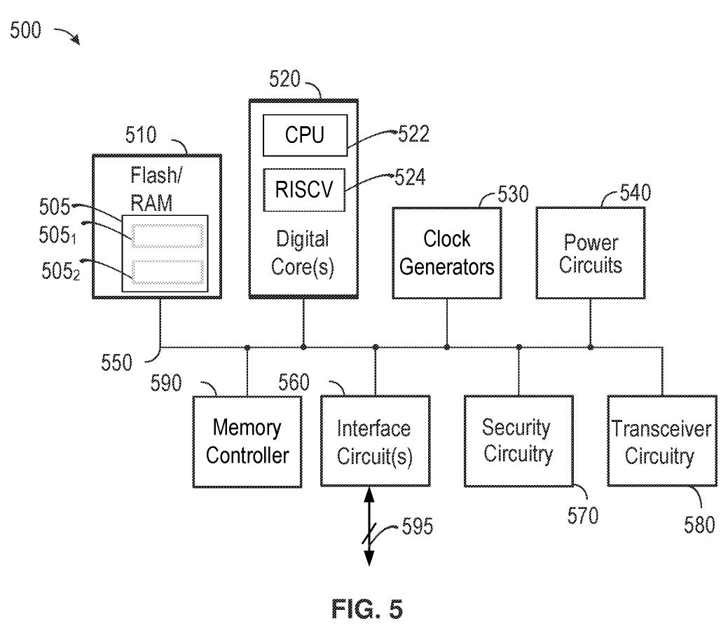

Referring now to FIG. 5, shown is a block diagram of a representative integrated circuit 500 that includes separate radio and protocol images in accordance with an embodiment. In the embodiment shown in FIG. 5, integrated circuit 500 may be, e.g., a multi-mode wireless transceiver that operates according to one or more wireless protocols or other device that can be used in a variety of use cases. In one or more embodiments, the circuitry of integrated circuit 500 shown in FIG. 5 may be implemented on a single semiconductor die or implemented on separate dies for wireless communication, MCU compute, external flash and/or other IP blocks needed to perform various functionalities.

Integrated circuit 500 may be included in a range of devices, but for purposes of discussion, it may be incorporated into an IoT device. In the embodiment shown, integrated circuit 500 includes a memory system 510 which in an embodiment may include volatile storage, such as RAM and non-volatile memory such as a flash memory. The flash memory is a non-transitory storage medium that can store instructions and data. These instructions include instructions of separately developed radio and protocol user images and associated jump table that, when executed, perform radio operations within integrated circuit 500 as described herein.

As further shown in FIG. 5, memory system 510 may store code 505, which may be a host application formed of a separate radio image 505₁(including a jump table) and at least one separate protocol user image 505₂having instructions that when executed cause radio operations to be performed. Integrated circuit 500 also may include a memory controller 590.

Memory system 510 couples via a bus 550 to one or more digital cores 520. In the high level shown in FIG. 5, cores 520 includes a central processing unit (CPU) 522, which may act as a host processor for integrated circuit 500 , and in one embodiment may be implemented as an ARM Cortex^{TM} core, and one or more coprocessors 524, which may be implemented as RISC-V processors to execute images 505_{1, 2}, in response to their loading by CPU 522. In turn, digital cores 520 may couple to clock generators 530 which may provide one or more phase locked loops or other clock generator circuitry to generate various clocks for use by circuitry of the IC.

As further illustrated, IC 500 also includes power circuitry 540. Additional circuitry may be present depending on particular implementation to provide various functionality and interaction with external devices. Such circuitry may include interface circuitry 560 which provides a digital communication interface with additional circuitry (such as another IC that can couple to IC 500 via a link 595). IC 500 also may include security circuitry 570 to perform wireless security techniques.

In addition, as shown in FIG. 5, transceiver circuitry 580 may be provided to enable transmission and reception of wireless signals, e.g., according to one or more of a local area or wide area wireless communication scheme, such as Matter, Zigbee, Bluetooth, BLE, IEEE 802.11, IEEE 802.15.4, cellular communication or so forth. Understand while shown with this high-level view, many variations and alternatives are possible.

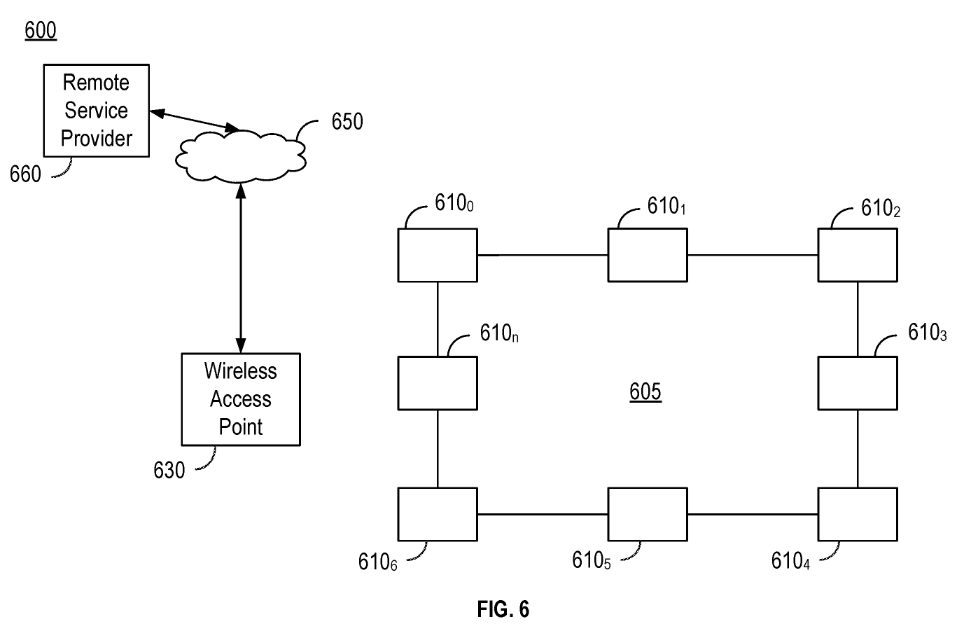

ICs such as described herein may be implemented in a variety of different devices as described above. Referring now to FIG. 6, shown is a high-level diagram of a network in accordance with an embodiment. As shown in FIG. 6, a network 600 includes a variety of devices, including IoT and other wireless devices that may include separately generated radio and protocol user images and associated jump table, as described herein.

In the embodiment of FIG. 6, a wireless mesh network 605 is present, e.g., in a building having multiple wireless devices 610₀₋ₙ. As shown, wireless devices 610, which may be IoT or other wireless devices, couple to an access point 630 that in turn communicates with a remote service provider 660 via a wide area network 650, e.g., the Internet. Understand while shown at this high level in the embodiment of FIG. 6, many variations and alternatives are possible.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
generating a first executable file for radio code to execute on at least one coprocessor of a wireless device, the first executable file having a pointer to a jump table, the jump table having a plurality of entries each to identify an entry point to a function in the radio code, the radio code to be used for a plurality of wireless protocols;
generating a second executable file for protocol code to execute on the at least one coprocessor, the second executable file having the pointer to the jump table, the protocol code to be used for one of the plurality of wireless protocols;
building, using the first executable file and the second executable file, a host application having the radio code separated from the protocol code, the host application to execute on a host processor of the wireless device; and
storing the host application in a non-volatile memory.

2. The method of claim 1, further comprising:
generating a first source file for the radio code and generating a second source file for the protocol code; and
associating a first linker file with the radio code and associating a second linker file with the protocol code, the first linker file comprising the pointer and the second linker file comprising the pointer.

3. The method of claim 2, further comprising:
generating the first executable file using the first source file and the first linker file; and
generating the second executable file using the second source file and the second linker file.

4. The method of claim 1, wherein building the host application comprises including instructions in the host application to cause the host processor to independently load the radio code to a first location in a memory of the wireless device and load the protocol code to a second location in the memory.

5. The method of claim 4, further comprising including the instructions in the host application to cause the host processor to independently load the radio code to the first location in the memory comprising a volatile memory associated with the at least one coprocessor and to load the protocol code to the second location in the memory comprising the volatile memory.

6. The method of claim 4, further comprising including the instructions in the host application to cause the host processor to independently load the radio code comprising the jump table, the pointer to identify a location of the jump table.

7. An apparatus comprising:
a host processor to execute applications; and
a wireless transceiver coupled to the host processor, the wireless transceiver comprising radio frequency (RF) circuitry, at least one radio coprocessor, a non-volatile memory and a volatile memory, wherein the host processor is to independently load a radio image into a first location of the volatile memory and load a protocol image into a second location of the volatile memory, wherein the radio image is separated from the protocol image in the volatile memory.

8. The apparatus of claim 7, wherein the host processor further is to independently load the radio image comprising a jump table, the jump table having a plurality of entries each to identify an entry point to a function in the radio image.

9. The apparatus of claim 8, wherein the radio image comprises a pointer to the jump table and the protocol image comprises the pointer to the jump table.

10. The apparatus of claim 9, wherein the at least one radio coprocessor is, during execution of the protocol image, to access a first application programming interface of the radio image using the pointer.

11. The apparatus of claim 10, wherein the at least one radio coprocessor is to obtain an offset to the first application programming interface in a header of the protocol image, the header to associate the offset with the first application programming interface.

12. The apparatus of claim 9, wherein the host processor is to independently load a second protocol image into a third location of the volatile memory, wherein the protocol image is associated with a first wireless protocol and the second protocol image is associated with a second wireless protocol.

13. The apparatus of claim 9, wherein the host processor is to dynamically swap a second protocol image for the protocol image in response to a switch of the wireless transceiver from communication via a first wireless protocol to communication via a second wireless protocol.

14. A method comprising:
executing, on a radio coprocessor of a wireless device, protocol code for a wireless protocol, the protocol code comprising a first call to a first application programming interface of radio code, the radio code separate from the protocol code;
in response to the first call, accessing a jump table using a jump table pointer included in the protocol code;
using the jump table to identify a location of the first application programming interface within the radio code; and
accessing the first application programming interface within the radio code at the location.

15. The method of claim 14, further comprising:
obtaining an offset to an entry of the jump table associated with the first application programming interface; and
accessing the entry of the jump table using the jump table pointer and the offset, the entry comprising the location of the first application programming interface within the radio code.

16. The method of claim 15, further comprising executing the first application programming interface to perform an operation.

17. The method of claim 16, further comprising executing, on the radio coprocessor, the protocol code using a result of the operation.

18. The method of claim 14, further comprising dynamically swapping, in a memory of the wireless device, the protocol code with second protocol code for a second wireless protocol, while maintaining the radio code in a memory.

19. The method of claim 14, further comprising:
loading, via a host processor of the wireless device, the radio code into a first location of a volatile memory of the wireless device; and
loading, via the host processor, the protocol code into a second location of the volatile memory, wherein the radio code is separated from the protocol code in the volatile memory.

20. The method of claim 19, further comprising independently loading the radio code from a first location in a non-volatile memory of the wireless device, and thereafter independently loading the protocol code from a second location in the non-volatile memory.
